(19) United States
(12) Patent Application Publication
(10) Pub. No.: US 2021/0210051 A1
(43) Pub. Date: Jul. 8, 2021

(54) METHODS AND APPARATUS TO CONFIGURE MULTIPLE DISPLAYS

(71) Applicant: Intel Corporation, Santa Clara, CA (US)

(72) Inventors: Andy B. Wang, Taipei (TW); Gavin Sung, Taipei (TW); Nee Shen Ho, Gelugor (MY); Tim Liu, New Taipei City (TW); Jason Y. Jiang, Taipei (TW); Gerry Juan, Taipei (TW); Tong Liang Chew, Gelugor (MY)

(21) Appl. No.: 17/212,834

(22) Filed: Mar. 25, 2021

(51) Int. Cl. G09G 5/12; G06K 7/14

(52) U.S. Cl. CPC G09G 5/12; G09G 2320/0693; G06K 7/1417

(57) ABSTRACT

Methods, apparatus, systems and articles of manufacture are disclosed to configure multiple displays. An example apparatus disclosed herein includes memory, and a processor to execute instructions to detect, via a tag reader on a first display, a tag on a second display, the first display and second display communicatively coupled to a computing device, determine, based on a location of the tag reader relative to the first display, a position of the second display relative to the first display, and update an operating system of the computing device based on the determined position.

### FIELD OF THE DISCLOSURE

This disclosure relates generally to computing devices and, more particularly, to methods and apparatus to configure multiple displays.

### BACKGROUND

In recent years, large visual displays including multiple synchronized monitors have become more common. The use of large visual displays increases the visual area available to display information to viewers of the displays. Multi-display configurations are commonly used in public places, offices, and video gaming applications. In many examples, multi-display configurations are controlled by a single computing device, which includes software to manage the multiple displays coupled thereto.

### BRIEF DESCRIPTION OF THE DRAWINGS

FIG. 1 is a block diagram of an example system in which teachings of this disclosure can be implemented.

FIG. 2 is a block diagram of the example display synchronizer of FIG. 1.

FIG. 3 is an example video frame.

FIG. 4 is a block diagram of the example multi-display orientation determiner of FIG. 1.

FIG. 5 is a front view of an example multi-display system illustrating the operation of the example display synchronizer of FIGS. 1 and 3.

FIG. 6 is a front view of an example multi-display system illustrating the operation of the example multi-display orientation determiner of FIGS. 1 and 4.

FIG. 7 is a flowchart representative of example machine readable instructions which may be executed to implement the example display synchronizer of FIGS. 1 and 3.

FIG. 8 is a flowchart representative of example machine readable instructions which may be executed to implement the example multi-display orientation determiner of FIGS. 1 and 4.

FIG. 9 is a block diagram of an example processing platform structured to execute the instructions of FIGS. 7 and/or 8 to implement the example multi-display orientation determiner and/or the example display synchronizer of FIGS. 1, 3, and/or 4.

The figures are not to scale. Instead, the thickness of the layers or regions may be enlarged in the drawings. In general, the same reference numbers will be used throughout the drawing(s) and accompanying written description to refer to the same or like parts. As used in this patent, stating that any part (e.g., a layer, film, area, region, or plate) is in any way on (e.g., positioned on, located on, disposed on, or formed on, etc.) another part, indicates that the referenced part is either in contact with the other part, or that the referenced part is above the other part with one or more intermediate part(s) located therebetween. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Stating that any part is in “contact” with another part means that there is no intermediate part between the two parts.

Descriptors “first,” “second,” “third,” etc., are used herein when identifying multiple elements or components which may be referred to separately. Unless otherwise specified or understood based on their context of use, such descriptors are not intended to impute any meaning of priority, physical order or arrangement in a list, or ordering in time but are merely used as labels for referring to multiple elements or components separately for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for ease of referencing multiple elements or components.

### DETAILED DESCRIPTION

Multiple display computing work and/or gaming stations provide productivity for their users. However, setting up multiple display computing work and/or gaming stations can be time-consuming, which is inhibitive to setting up temporary multiple display computing stations (e.g., stations for competitive electronic sports (esports), etc.). Additionally, multiple displays need to be properly oriented (e.g., in landscape mode, in portrait mode, etc.) and in proper spatial relationship (e.g., to the left or right of each other, above or below each other, etc.), which can further delay users as manual configuration via the computing operating system is required. Some operating systems include interfaces that allow users to manually arrange and configure display but doing so may not be convenient for users of mobile and/or temporary work and/or gaming computing stations.

Examples disclosed herein allow users of multi-display stations to quickly couple and/or configure peripheral displays in the stations automatically. Examples disclosed herein include primary displays with tag readers (e.g., radio-frequency identification (RFID tag readers, etc.) and peripheral displays with tags (e.g., tag readers, etc.). In some examples disclosed herein, the tag readers of the primary display can detect tags embedded in peripheral displays to determine the relative arrangement of the primary display and the peripheral displays. In some examples disclosed herein, the orientation of the peripheral display can be determined based on the detected tag of the peripheral display. In some examples disclosed herein, the operating system of a computing device associated with the primary display can be automatically configured to properly reflect the determined arrangement and orientation of the coupled displays.

Display walls using multiple synchronized panels to present unified visual content that spans all of the panels are more commonly being used in public spaces, such as retail establishments and airports. In some examples, these panels are controlled by multiple controllers synchronized with a master clock. Each of these panels needs to be refreshed at the same time to maintain the perception that the visual content spanning the multiple panels appears as if it is being presented as a single consistent image or video. Some prior-art methods, such as multichip generator locking (genlock), are silicon features that enable the synchronization of frames across all of the panel in a multi-panel system. However, each of the panels in such systems needs to use the same phase-locked loop (PLL) reference clock frequency, which limits the types of monitors or panels that can be synchronized (e.g., the same or similar monitors must be used as monitors, etc.) as well as requiring each platform to drive the same panels.

Examples disclosed herein allow users to set-up a multi-panel display system using panels that have different timing requirements, giving them better flexibility on panel choice. Examples disclosed herein enable synchronization of disparate types of displays by modifying refresh timings for each monitor in the multi-panel display system. In some examples disclosed herein, frame synchronization pins are coupled between platforms. Examples disclosed herein enable different display outputs to be used in the same multi-panel display system. Examples disclosed herein receive the display properties from each monitor in the display wall and overwrite the display properties to ensure the timing characteristics of each monitor are synchronized to ensure the display is seamless. In some examples disclosed herein, a primary system-on-chip (SOC) configures the vertical blanking interval of each monitor to ensure the vertical total timing of each monitor is the same. In some examples disclosed herein, a primary SOC is assigned to drive the frame synchronization signal across a secondary SOC and displays. In some examples disclosed herein, the primary SOC generates the frame synchronization signal via a frame synchronization coupling the primary SOC to the secondary SOC. In some examples disclosed herein, the secondary SOC receives the frame synchronization signal from the primary SOC, which enables the secondary SOC to trigger a vertical blanking interrupt when it receives a vertical reference notification from the wire.

As used herein, “display,” “screen,” “display screen,” “monitor,” and “display monitor” have the same meaning and refer to a structure to visibly convey an image, text, and/or other visual content to a human in response to an electrical control signal. As used herein, “a multi-panel display system” refer to structures that are composed of multiple displays that operate in unison to visibly convey an image, text, and/or other visual content to a human in response to an electrical control signal. As used herein, individual displays included in a multi-panel display system are referred to herein as “panels.” As used herein, the term “primary display” refers to the default display associated with a computing system, which often displays information during the booting of the computing device. Primary displays are often integrated with the computing device (e.g., laptop, tablet, etc.). The term “secondary display” refers to other displays coupled to a computing device. The terms “peripheral display” and “secondary display” are used interchangeably. Secondary or peripheral displays may be standalone components (e.g., a television screen, a computer monitor, etc.) that do not include an internal computing system. Further, the computing systems with an integrated display may also serve as a secondary or peripheral display to a separate computing system.

As used herein in the context of describing the position and/or orientation of a first object relative to a second object, the term “substantially parallel” encompasses the term parallel and more broadly encompasses a meaning whereby the first object is positioned and/or oriented relative to the second object at an absolute angle of no more than ten degrees (10°) from parallel. For example, a first axis that is substantially parallel to a second axis is positioned and/or oriented relative to the second axis at an absolute angle of no more than ten degrees (10°) from parallel.

As used herein in the context of describing the relative of timing of two events, the term “substantially the same time” refers to events that occur such that human would perceive them as occurring at the same time. As such, “substantially the same time” typically refers to events that occur within 15 milliseconds of one another.

As used herein in the context of describing the position and/or orientation of a first object relative to a second object, the term “substantially perpendicular” encompasses the term perpendicular and more broadly encompasses a meaning whereby the first object is positioned and/or oriented relative to the second object at an absolute angle of no more than ten degrees (10°) from perpendicular. For example, a first axis that is substantially perpendicular to a second axis is positioned and/or oriented relative to the second axis at an absolute angle of no more than ten degrees (10°) from perpendicular.

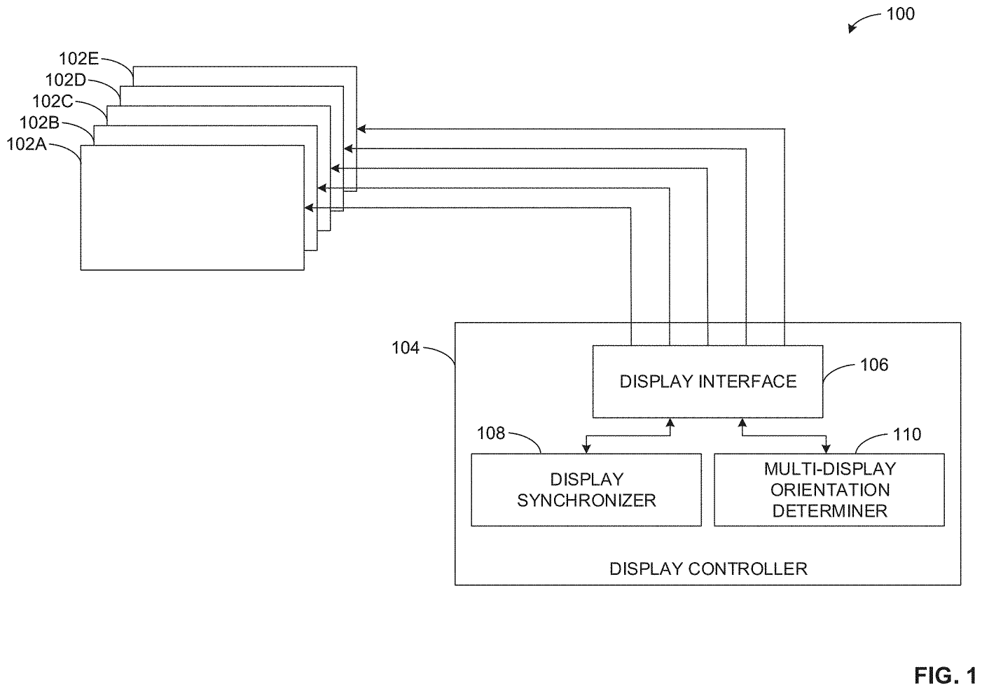

FIG. 1 is a block diagram of an example system 100 in which teachings of this disclosure can be implemented. In the illustrated example of FIG. 1, the system includes an example first display 102A, an example second display 102B, an example third display 102C, an example fourth display 102D, and an example fifth display 102E, which are each coupled to an example display controller 104. The example display controller 104 includes an example display interface 106, an example display synchronizer 108, and an example multi-display orientation determiner 110.

The example displays 102A, 102B, 102C, 102D, 102E are discrete devices (e.g., monitors, etc.) that are each communicatively coupled to the display controller 104. The example displays 102A, 102B, 102C, 102D, 102E may be implemented as a light-emitting diode (LED) display, a liquid crystal display (LCD), a touchscreen, and/or any other suitable type of screen. Some or all of the displays 102A, 102B, 102C, 102D, 102E can be integrated into a computing device (e.g., a laptop, a tablet, etc.). In such examples, the display controller 104 can be implemented within the computing device. Each of the displays 102A, 102B, 102C, 102D, 102E has display properties associated therewith. As used herein, “display properties” refer to the hardware attributes of each display, and can include the refresh rate, resolution, video time characteristics (e.g., vertical blanking intervals, horizontal blanking intervals, vertical frequency, horizontal frequency, clock rate, etc.), luminance, physical size, etc.

The display controller 104 is a hardware device that generates one or more video/audio signals to be transmitted to the displays 102A, 102B, 102C, 102D, 102E. For example, the display controller 104 can divide the video to be generated such that the displays 102A, 102B, 102C, 102D, 102E depict a unified visual presentation. In some examples, the display controller 104 coordinates the timing of the video signal transmitted to the displays 102A, 102B, 102C, 102D, 102E. In some examples, the display controller 104 can determine the orientation of the displays 102A, 102B, 102C, 102D, 102E based on information received from the displays 102A, 102B, 102C, 102D, 102E.

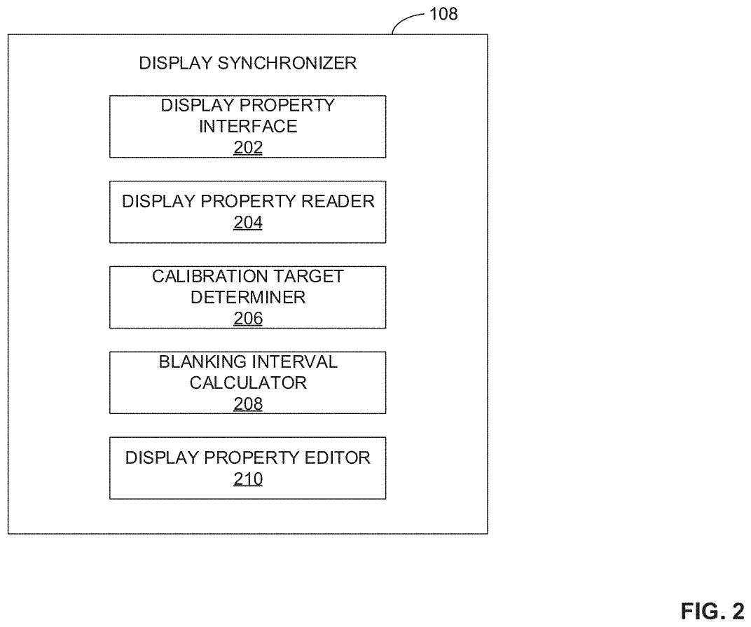

The example display synchronizer 108 synchronizes the output of the displays 102A, 102B, 102C, 102D, 102E by ensuring each of the displays 102A, 102B, 102C, 102D, 102E refresh at the same time. For example, the display synchronizer 108 can determine a calibration length of the video frame signal based on the properties of the displays 102A, 102B, 102C, 102D, 102E (e.g., the resolution of the displays 102A, 102B, 102C, 102D, 102E, the refresh rate of the displays 102A, 102B, 102C, 102D, 102E, etc.). In some examples, the display synchronizer 108 can edit the blanking intervals of the displays 102A, 102B, 102C, 102D, 102E to ensure the length of the video frame signal is the same for each of the displays 102A, 102B, 102C, 102D, 102E. The example display synchronizer 108 ensures all the displays 102A, 102B, 102C, 102D, 102E are perceived as if each of the displays 102A, 102B, 102C, 102D, 102E are running with the same timing and ready to receive the vertical frame reference at the same time. An example implementation of the display synchronizer 108 is described below in conjunction with FIG. 2.

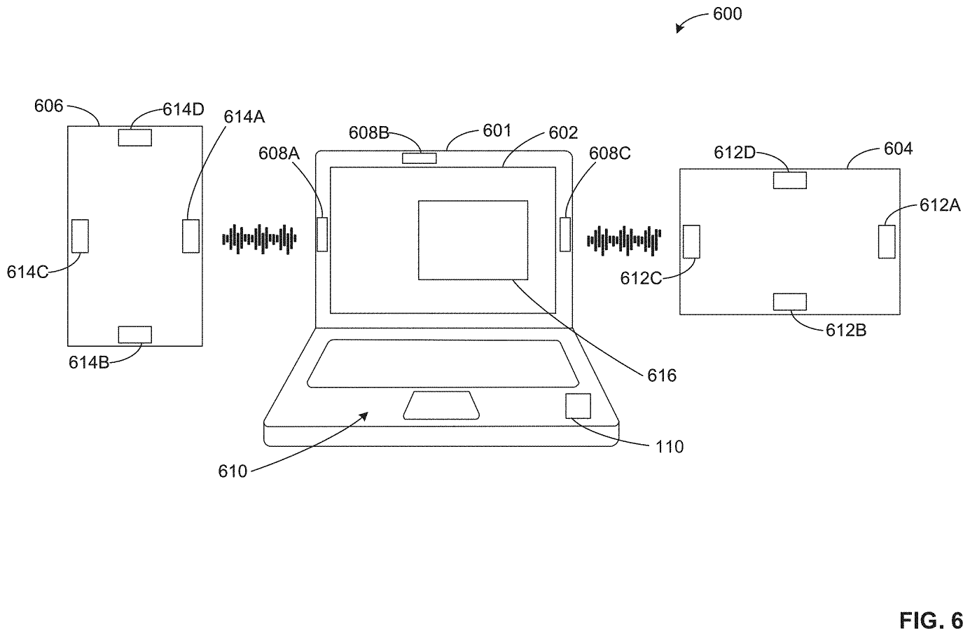

In some examples, one or more of the example displays 102A, 102B, 102C, 102D, 102E can be primary displays, which include one or more tag readers that enable the primary display to detect embedded tags in the other displays 102A, 102B, 102C, 102D, 102E. In such examples, the displays 102A, 102B, 102C, 102D, 102E that include embedded tags are referred to as secondary displays. In some examples, some or all of the displays 102A, 102B, 102C, 102D, 102E can include both tag readers and tags. In such examples, the display controller 104 can determine the spatial relationship and/or orientation of the displays 102A, 102B, 102C, 102D, 102E based on the output of the tag readers. An example system including primary and secondary displays is described below in conjunction with FIG. 6.

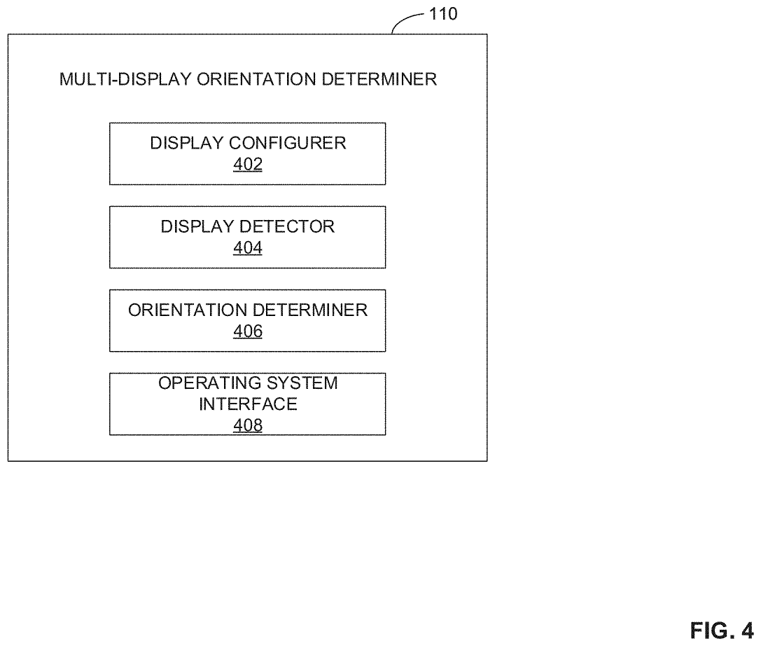

The example multi-display orientation determiner 110 determines the orientation and layout of the displays 102A, 102B, 102C, 102D, 102E. In some examples, the multi-display orientation determiner 110 determines the orientation of the primary display (e.g., the first display 102A, etc.). In some examples, the multi-display orientation determiner 110 interacts with the tag readers of the primary display to determine which of the other displays (e.g., the displays 102B, 102C, 102D, 102E, etc.) are adjacent to the primary display 102A. In some examples, the multi-display orientation determiner 110 receives display properties from the primary display and the secondary displays to properly configure the displays 102A, 102B, 102C, 102D, 102E. In some examples, the multi-display orientation determiner 110 can interact with the operating system of a computing device (e.g., the computing device associated with the primary display, a computing device associated with the display controller 104, etc.) to determine the current orientations and/or spatial relationships of the displays 102A, 102B, 102C, 102D, 102E. An example implementation of the multi-display orientation determiner 110 is described below in conjunction with FIG. 4.

The example display interface 106 enables audio/visual information to be transmitted to the example displays 102A, 102B, 102C, 102D, 102E from the display controller 104. In some examples, the example displays 102A, 102B, 102C, 102D, 102E can be connected to the display interface 106 via one or more wired connections. In some examples, display interface 106 can be implemented by one or more high-definition multimedia interface(s) (HDMI), DisplayPort (DP) interface(s), embedded DisplayPort (eDP) interface(s), Mobile Industry Processor Interface(s) (MIPI), display serial interface(s) (DSI), portable digital media interface(s) (PDMI), video graphics array (VGA) interface(s), digital visual interface(s) (DVI), mobile high-definition link (MHL) interface(s), digital flat panel (DFP) interface(s), and/or any other suitable video and/or audio interface(s). Additionally or alternatively, the display interface 106 can connect to the displays 102A, 102B, 102C, 102D, 102E via one or more wireless connections. In such examples, the displays 102A, 102B, 102C, 102D, 102E can communicate via any suitable means and/or protocol (e.g., Wi-Fi, a mobile communication network, Bluetooth, etc.).

FIG. 2 is a block diagram of the display synchronizer 108 of FIG. 1. The display synchronizer 108 includes an example display property interface 202, an example display property reader 204, an example calibration target determiner 206, an example blanking interval calculator 208, and an example display property editor 210.

The display property interface 202 retrieves display property information from each coupled display. For example, the display property interface 202 can request display property information from each display 102A, 102B, 102C, 102D, 102E via the display interface 106. In other examples, the displays 102A, 102B, 102C, 102D, 102E can automatically transmit the respective display properties to display property interface 202 when they are coupled to the display synchronizer 108 and/or the display controller 104. In some examples, the display property interface 202 can receive the display information via a user interface (e.g., a user interface associated with the display controller 104, etc.). In some such examples, the display property interface 202 can prompt a user to input the display properties. In some examples, the display property interface 202 receives the display property information from a tag reader that acquires the display property information from a tag embedded in the displays 102A, 102B, 102C, 102D, 102E. In some examples, the display property interface 202 can cause a presentation of a synchronized video presentation on the displays 102A, 102B, 102C, 102D, 102E based on the output(s) of the display property reader 204, the calibration target determiner 206, the blanking interval calculator 208, and the display property editor 210.

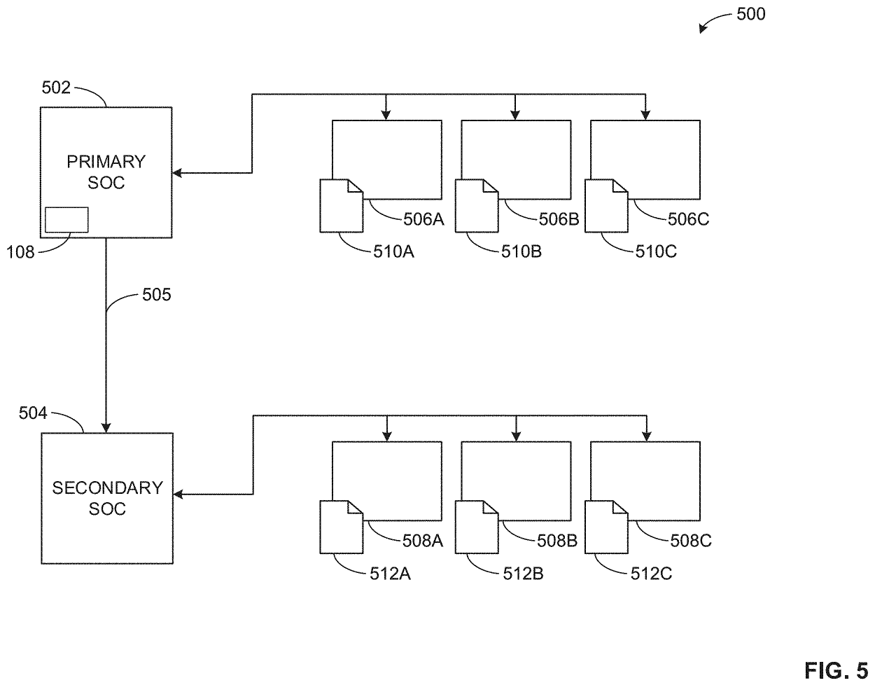

An example system displaying the function of the display property interface 202 is described below in conjunction with FIG. 5.

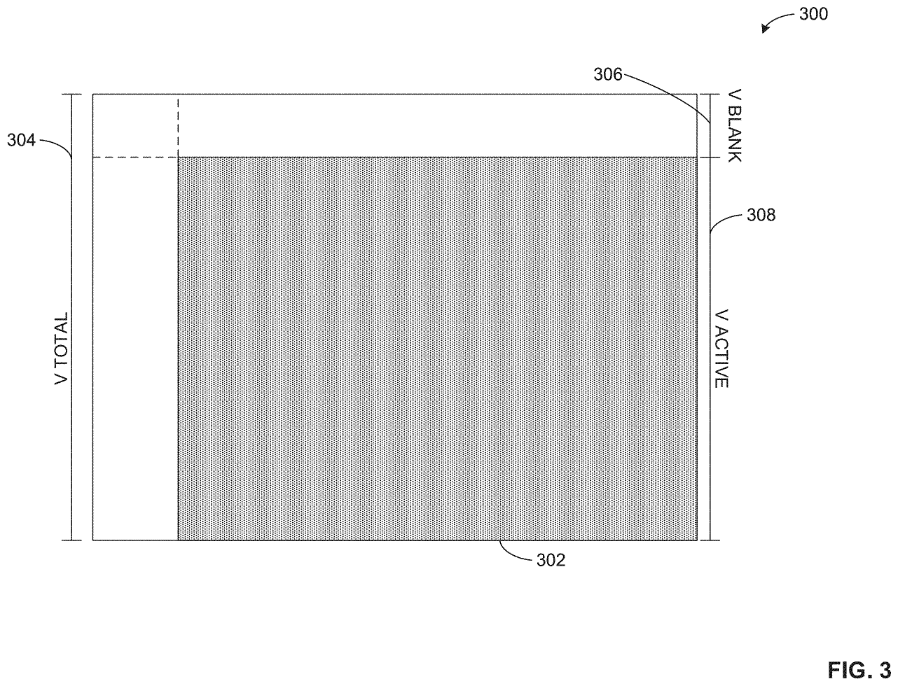

The example display property reader 204 reads the display properties retrieved by the display property interface 202. For example, the display property reader 204 can read the video frame timing characteristics, the refresh rate, and the screen resolution of each of the displays 102A, 102B, 102C, 102D, 102E. In some examples, the display property reader 204 can determine the default vertical blanking of each of the coupled displays 102A, 102B, 102C, 102D, 102E. In other examples, the display property reader 204 can determine the display properties of each of the coupled displays 102A, 102B, 102C, 102D, 102E by any other suitable means (e.g., user input, directly querying the displays 102A, 102B, 102C, 102D, 102E, etc.). The example properties read by the display property reader 204 are described below in conjunction with FIG. 3.

The example calibration target determiner 206 determines a target calibration vertical total dimension to calibrate the displays 102A, 102B, 102C, 102D, 102E. As used herein, the calibration vertical total dimension corresponds to the total amount of time for each of the displays to individually refresh with new a video frame. More particularly, the calibration vertical total dimension includes the time associated with scanning through both the vertical active interval and the vertical active interval of the video frame (as discussed in further detail below in conjunction with FIG. 3). Determining a target calibration vertical total dimension enables the different displays 102A, 102B, 102C, 102D, 102E to refresh in a synchronized manner, which may not otherwise be possible because of different default vertical blanking intervals and/or different default vertical active areas for the different displays. In some examples, the calibration target determiner 206 can determine the calibration vertical total dimension based on the largest (e.g., greatest, etc.) vertical resolution amongst the displays 102A, 102B, 102C, 102D, 102E. As used herein, the vertical resolution of a display refers to the total vertical dimensions of the display corresponding to both the default vertical blanking interval and the default vertical active interval. In some examples, the calibration target determiner 206 can determine the calibration vertical total dimension as the largest (e.g., greatest, etc.) horizontal resolution (including both the default horizontal blanking interval and the default horizontal active interval) among the displays 102A, 102B, 102C, 102D, 102E. In other examples, the calibration target determiner 206 can determine the calibration vertical total dimension as a multiple of the largest vertical resolution among the displays 102A, 102B, 102C, 102D, 102E (e.g., 1.1× the vertical resolution, 1.5× the vertical resolution, etc.). In other examples, the calibration target determiner 206 can determine the calibration vertical total dimension as a fixed sum added to the largest vertical resolution among the displays 102A, 102B, 102C, 102D, 102E (e.g., the vertical resolution plus 30 lines, the vertical resolution plus 5 lines, etc.). In other examples, the calibration target determiner 206 can determine the calibration vertical total dimension by any other suitable means.

The example blanking interval calculator 208 determines synchronization blanking interval(s) (e.g., synchronization vertical blanking interval(s), synchronization horizontal blanking interval(s), etc.) to calibrate each of the displays 102A, 102B, 102C, 102D, 102E based on the properties of each of the displays 102A, 102B, 102C, 102D, 102E, and the target calibration vertical total dimension. For example, the blanking interval calculator 208 can determine the synchronization blanking interval for each display 102A, 102B, 102C, 102D, 102E based on the difference between the active video signal portion associated with each of the displays 102A, 102B, 102C, 102D, 102E and the target calibration vertical total dimension. In other examples, the blanking interval calculator 208 can calculate the synchronization blanking interval for each of the displays 102A, 102B, 102C, 102D, 102E by any other suitable means.

The example display property editor 210 edits the display properties of the displays 102A, 102B, 102C, 102D, 102E. For example, the display property editor 210 can edit the display properties of the displays 102A, 102B, 102C, 102D, 102E to include the calculated synchronization blanking interval. In some examples, the display property editor 210 creates a temporary copy of the display properties and edits the copy to include the calculated synchronization blanking interval. In other examples, the display property editor 210 can directly edit the retrieved copy of the display property editor 210. In other examples, the display property editor 210 directly edits the display properties stored at the displays 102A, 102B, 102C, 102D, 102E.

While an example manner of implementing the display synchronizer 108 of FIG. 1 is illustrated in FIG. 2, one or more of the elements, processes and/or devices illustrated in FIG. 2 may be combined, divided, re-arranged, omitted, eliminated and/or implemented in any other way. Further, the example display property interface 202, the example display property reader 204, the example calibration target determiner 206, the example blanking interval calculator 208, the example display property editor 210 and/or, more generally, the example display synchronizer 108 of FIGS. 1 and 2 may be implemented by hardware, software, firmware and/or any combination of hardware, software and/or firmware. Thus, for example, any of the example display property interface 202, the example display property reader 204, the example calibration target determiner 206, the example blanking interval calculator 208, and/or the example display property editor 210 and/or, more generally, the example display synchronizer 108 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example display property interface 202, the example display property reader 204, the example calibration target determiner 206, the example blanking interval calculator 208, and/or the example display property editor 210 is/are hereby expressly defined to include a non-transitory computer readable storage device or storage disk such as a memory, a digital versatile disk (DVD), a compact disk (CD), a Blu-ray disk, etc. including the software and/or firmware. Further still, the example display synchronizer 108 of FIG. 2 may include one or more elements, processes and/or devices in addition to, or instead of, those illustrated in FIG. 2, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 3 is an example diagram of a video frame 300 generated by the display controller 104. In the illustrated example of FIG. 3, the video frame 300 has an example active video area 302, an example vertical total dimension (VTOTAL) 304, an example vertical blanking interval (VBLANK) 306, and an example vertical active interval (VACTIVE) 308. The video frame 300 is a visual representation of a video signal transmitted from the display controller 104 to one of the displays 102A, 102B, 102C, 102D, 102E. The display controller 104 may generate and provide similar video frames 300 to each of the other displays 102A, 102B, 102C, 102D, 102E. However, in some examples, the visual content in the active video area 302 for each display 102A, 102B, 102C, 102D, 102E corresponds to a different portion of an overall video feed that matches the particular position of each display 102A, 102B, 102C, 102D, 102E relative to the others. To ensure the displays 102A, 102B, 102C, 102D, 102E appear to be synchronized (e.g., seamless, etc.) as to the timing that each display refreshes, the size of the video frame 300 provided to each display (e.g., the length of the video signal transmitted to the displays 102A, 102B, 102C, 102D, 102E, etc.) must be substantially the same. While examples described herein are described in conjunction with vertical dimensions/properties of the screen, they can similarly be applied to the horizontal dimensions of the video frame 300 (e.g., the horizontal total, the horizontal blanking interval, the horizontal active interval, etc.).

The total vertical dimension of the video frame 300 (e.g., the vertical resolution of the screen, etc.) is referred to herein as the vertical total dimension 304 (VTOTAL). That is, the vertical total dimension 304 is the total number of one pixel tall horizontal lines composing the video frame 300. In some examples, the vertical total dimension 304 defines the total vertical resolution of the video frame 300. In some examples, the minimum value of the vertical total dimension 304 is the physical vertical dimension of the corresponding display 102A, 102B, 102C, 102D, 102E to which the video frame 300 is provided. The vertical blanking interval 306 is the portion of the video frame 300 associated with a video synchronization signal. The example vertical active interval 308 is the portion of the video frame 300 associated with the visible parts of the video frame (e.g., the portion of the video frame 300 that is presented to a user of a display, etc.). The vertical blanking interval 306 is the portion of the video frame 300 that buffers the video frame 300 from the previous video frame. That is, the vertical blanking interval 306 represents the period of time between the transmission of the last pixel of the preceding frame and the first pixel transmitted of the video frame 300. Different makes and models of displays may have different default sizes of vertical blanking intervals 306 making it difficult to use such displays in a single multi-display system because the timing of each frame refresh across the different displays will not be synchronized. However, in accordance with teachings disclosed herein, the vertical blanking interval 306 of each of the displays 102A, 102B, 102C, 102D, 102E is adjusted and/or generated by the display controller 104 such that the vertical total dimension 304 of each of the displays 102A, 102B, 102C, 102D, 102E is consistent (e.g., corresponds to the same target calibration vertical total dimension). As such, the display controller 104 synchronizes each panel (e.g., the displays 102A, 102B, 102C, 102D, 102E, etc.) of a multi-panel display system and the source of the video (e.g., software of a computing device associated with the display controller 104). Defining a consistent vertical blanking interval 306 across all of the displays 102A, 102B, 102C, 102D, 102E ensures the active video area 302 of the separate video frame 300 sent to each display is fully rendered in a refresh period that is common to all of the displays 102A, 102B, 102C, 102D, 102E. The default vertical blanking interval 306 associated with each display 102A, 102B, 102C, 102D, 102E may be adjusted to ensure each of the displays 102A, 102B, 102C, 102D, 102E have the same vertical timing. That is, the display synchronizer 108 can adjust the vertical blanking interval 306 of the video frame 300 to ensure the vertical total dimension of each video frame transmitted to the displays 102A, 102B, 102C, 102D, 102E is equal.

As such, the example vertical total dimension 304 is composed of a vertical active interval 308 associated with the actual image to be presented to a user (e.g., a visible portion of the video frame 300, etc.) and a vertical blanking interval 306 associated with a signal used to control the timing and synchronization of the video frames transferred to the displays 102A, 102B, 102C, 102D, 102E, etc.).

FIG. 4 is a block diagram of the example multi-display orientation determiner 110 of FIG. 1. In the illustrated example of FIG. 4, the multi-display orientation determiner 110 includes an example display configurer 402, an example display detector 404, an example orientation determiner 406, and an example operating system interface 408.

The example display configurer 402 configures the display properties of each of the displays 102A, 102B, 102C, 102D, 102E coupled to the display controller 104 via the display interface 106. For example, the display configurer 402 can receive the display properties via the display interface 106 and/or display detector 404. In such examples, the display configurer 402 can ensure the display properties of each coupled display are configured to have the appropriate refresh rate, resolution, and/or timing characteristics. In some examples, the display configurer 402 can configure the orientation of the video output of the coupled displays (e.g., landscape video orientation, portrait video orientation, etc.).

The example display detector 404 detects when new secondary displays are coupled to the primary display (e.g., the first display 102A, etc.). For example, the display detector 404 can detect when a new display is coupled to the display controller 104 via the display interface 106. In some examples, the display detector 404 can detect when a new secondary display (e.g., the displays 102B, 102C, 102D, 102E, etc.) is coupled to the system via a tag reader embedded in an already detected display (e.g., the primary display 102A and/or one of the secondary displays 102B, 102C, 102D, 102E, etc.). In some examples, the display detector 404 can cause each of the displays 102A, 102B, 102C, 102D, 102E to transfer display properties to the display controller 104. In other examples, the display detector 404 can receive the display properties by any other suitable means.

The example orientation determiner 406 determines the physical orientation of a coupled secondary display. For example, the orientation determiner 406 can determine the physical orientation of the primary display coupled to the display controller 104. In some examples, the orientation determined 406 can determine the physical orientation of the primary display based on a user input. Additionally or alternatively, the orientation determiner 406 can determine based on a sensor reading of the primary display (e.g., a graviton, an inertia sensor, etc.) and/or a default position of the primary display.

The orientation determiner 406 can determine the orientation of a coupled secondary display based on the tag reader disposed in the primary display. In some examples, each primary and/or secondary display includes multiple tags and/or tag readers positioned adjacent different edges of the display (e.g., a top tag above the display, a bottom tag below the display, and left and right tags on either side of the display) to enable the orientation determiner 406 to determine the orientation of adjacent displays. For example, the orientation determiner 406 can determine a secondary display adjacent the top tag reader of the primary display is in the landscape orientation if the adjacent tag of the secondary display is associated with a long side of the secondary display. Similarly, the orientation determiner 406 can determine a secondary display adjacent the top tag reader of the primary display is in the portrait orientation if the adjacent tag of the secondary display is associated with a short side of the secondary display. In some examples, the orientation determiner 406 can determine a secondary display adjacent the left/right tag reader of the primary display is in the landscape orientation if the adjacent tag of the secondary display is associated with a short side of the secondary display. Similarly, the orientation determiner 406 can determine a secondary display adjacent the left/right tag reader of the primary display is in the portrait orientation if the adjacent tag of the secondary display is associated with a long side of the secondary display. In some examples, the orientation determiner 406 can determine a secondary display adjacent the bottom tag reader of the primary display is in the landscape orientation if the adjacent tag of the secondary display is associated with a long side of the secondary display. Similarly, the orientation determiner 406 can determine a secondary display adjacent the left/right tag reader of the primary display is in the portrait orientation if the adjacent tag of the secondary display is associated with a short side of the secondary display.

The example operating system interface 408 interfaces and communicates with an operating system associated with the display controller 104 and/or the primary display 102A. For example, the operating system interface 408 can cause the operating system to properly order and orient the primary display and selected secondary displays. That is, the operating system interface 408 can ensure the operating system is properly configured to reflect the physical orientation and layout of the coupled displays.

While an example manner of implementing the example multi-display orientation determiner 110 of FIG. 1 is illustrated in FIG. 4, one or more of the elements, processes and/or devices illustrated in FIG. 4 may be combined, divided, re-arranged, omitted, eliminated and/or implemented in any other way. Further, the example display configurer 402, the example display detector 404, the example orientation determiner 406, the example operating system interface 408 and/or, more generally, the example multi-display orientation determiner 110 of FIG. 3 may be implemented by hardware, software, firmware and/or any combination of hardware, software and/or firmware. Thus, for example, any of the example display configurer 402, the example display detector 404, the example orientation determiner 406, the example operating system interface 408 and/or, more generally, the example multi-display orientation determiner 110 and/or, more generally, the example multi-display orientation determiner 110 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example display configurer 402, the example display detector 404, the example orientation determiner 406, and/or the example operating system interface 408 is/are hereby expressly defined to include a non-transitory computer readable storage device or storage disk such as a memory, a digital versatile disk (DVD), a compact disk (CD), a Blu-ray disk, etc. including the software and/or firmware. Further still, the example multi-display orientation determiner 110 of FIG. 1 may include one or more elements, processes and/or devices in addition to, or instead of, those illustrated in FIG. 4, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

FIG. 5 is a front view of a multi-display system 500 illustrating the operation of the display synchronizer 108 of FIGS. 1 and 2. In the illustrated example of FIG. 5, the display synchronizer 108 is included in and/or otherwise implemented by an example primary SOC 502. The primary SOC 502 is communicatively coupled to an example secondary SOC 504 via an example frame synchronization pin 505. The primary SOC 502 is further communicatively coupled to an example first panel 506A, an example second panel 506B, and an example third panel 506C. The secondary SOC 504 is communicatively coupled to an example fourth panel 508A, an example fifth panel 508B, and an example sixth panel 508C. The panels 506A, 506B, 506C, 508A, 508B, 508C have corresponding example first display property information 510A, example second property information 510B, example third display property information 510C, example fourth display property information 512A, example fifth display property information 512B, and example sixth display property information 512C. In some examples, the different panels 506A, 506B, 506C, 508A, 508B, 508C may operate using different phase lock loop (PLL) reference clock frequencies such that conventional methods to synchronize the displays will not work. Further, in some examples, different ones of the panels 506A, 506B, 506C, 508A, 508B, 508C may be provided video data using different types of video input (e.g., HDMI, DP, eDP, MIPI, DSI, PDMI, VGA, DVI, MHL, DFP, etc.).

The primary SOC 502 is an integrated circuit and/or other hardware that implements the functions of a computing system. For example, the primary SOC 502 can include a central processing unit (CPU), volatile memory, non-volatile memory, one or more interfaces, a graphics processing unit (GPU), and/or other hardware components. In some examples, some or all of the hardware components can be implemented by another computing device. In other examples, the functions of the primary SOC 502 can instead be implemented by another computing device (e.g., a personal computer, a laptop, a server, a controller, a microcontroller, etc.). In the illustrated example, the display synchronizer 108 and/or the display controller 104 of FIG. 1 is implemented via the primary SOC 502. In the illustrated example of FIG. 5, the primary SOC 502 is communicatively coupled (e.g., via a wired and/or wireless connection described in conjunction with FIG. 1, etc.) to the panels 506A, 506B, 506C. In some examples, the primary SOC 502 is incorporated into a device that includes the first panel 506A. While the primary SOC 502 is depicted as coupled to three panels 506A, 506B, 506C, the primary SOC 502 can be coupled to fewer and/or additional displays and coupled to additional secondary SOCs.

In some examples, the secondary SOC 504 can be implemented via a device similar to the that of the primary SOC 502. In other examples, the secondary SOC 504 can be implemented by a computing device with reduced computing properties when compared to the primary SOC 502. In other examples, the primary SOC 502 can be implemented by any other suitable computing device. The primary SOC 502 is communicatively coupled to the secondary SOC 504 via an example frame synchronization pin 505. The frame synchronization pin 505 transmits information (e.g., display timing information, the display property information 512A, 512B, 512C, other information, etc.) between the primary SOC 502 and the secondary SOC 504. More particularly, in some examples, the primary SOC 502 drives a reference clock for all of the panels 506A, 506B, 506C, 508A, 508B, 508C that is provided to the secondary SOC 504 via the frame synchronization pin 505 so that both SOCs 502, 504 drive their respective displays in synchronization. Further, in some examples, the primary SOC 502 transmits a frame synchronization signal to the secondary SOC 504 to trigger the refreshing of (e.g., provide a vertical reference for a new video frame for) each of the associated panels 508A, 508B, 508C controlled by the secondary SOC 504 at the same time that the panels 506A, 506B, 506C controlled by the primary SOC 502 are also refreshed. This single trigger will cause all of the panels 506A, 506B, 506C, 508A, 508B, 508C to refresh at the same time because the default vertical blanking interval for individual ones of the panels (which may differ from one another) have been modified so that the total vertical dimensions correspond to the calibration vertical total dimension as discussed above. In some examples, the SOCs 502, 504 have a limited number of displays that may be coupled to them due to hardware and/or software limitations (e.g., 3 displays, 4 displays, etc.). In the illustrated example of FIG. 5, the frame synchronization pin 505 is implemented by a wired connection (e.g., fiber optical cable, a coaxial cable, a triaxial cable, etc.).

The panels 506A, 506B, 506C, 508A, 508B, 508C are displays positioned together to form a multi-panel display system. That is, while the panels 506A, 506B, 506C, 508A, 508B, 508C are shown spaced apart in FIG. 5 for purposes of clarity, in some examples, the panels 506A, 506B, 506C, 508A, 508B, 508C may be in close proximity or abutting one other so that the images presented on the panels 506A, 506B, 506C, 508A, 508B, 508C form a singular media presentation (e.g., a media broadcast, a large advertisement, etc.). Each of panels 506A, 506B, 506C, 508A, 508B, 508C have a default (e.g., native) vertical blanking interval and an associated total vertical dimension (e.g., vertical resolution). The example panels 506A, 506B, 506C, 508A, 508B, 508C can implement the example displays 102A, 102B, 102C, 102D, 102E.

In operation, the primary SOC 502 requests the display property information 510A, 510B, 510C via the connections to the panels 506A, 506B, 506C and the secondary SOC 504 requests the display property information 512A, 512B, 512C via the connections to the panels 508A, 508B, 508C. The secondary SOC 504 transmits the display property information 512A, 512B, 512C to the primary SOC 502 via the frame synchronization pin 505. In some examples, the display synchronizer 108 determines the maximum total vertical dimension among the different panels 506A, 506B, 506C, 508A, 508B, 508C. The display synchronizer then determines the calibration vertical total dimension based on the maximum vertical total dimension among the panels 506A, 506B, 506C, 508A, 508B, 508C. The display synchronizer 108 can calculate the synchronization vertical blanking interval for each of the panels 506A, 506B, 506C, 508A, 508B, 508C (which may be different than the corresponding default vertical blanking interval for each panel) based on the calibration vertical total dimension and update the display property information 510A, 510B, 510C, 512A, 512B, 512C. After the display property information 510A, 510B, 510C, 512A, 512B, 512C have been updated to include the synchronization vertical blanking interval, the panels 506A, 506B, 506C, 508A, 508B, 508C will operate with timing characteristics that appear seamless (e.g., each of the displays will refresh at the same time).

FIG. 6 is a front view of a multi-display system 600 illustrating the operation of the multi-display orientation determiner 110 of FIGS. 1 and 4. The system 600 includes an example computing device 601 with an example primary display 602, an example first secondary display 604, and an example second secondary display 606. In the illustrated example of FIG. 6, the example computing device includes an example first tag reader 608A, an example second tag reader 608B, an example third tag reader 608C, and an example user interface 610. The first secondary display 604 includes an example first tag 612A, an example second tag 612B, an example third tag 612C, and an example fourth tag 612D. The second secondary display 606 includes an example fifth tag 614A, an example sixth tag 614B, an example seventh tag 614C, and an example eighth tag 614D. In the illustrated example of FIG. 6, the computing device 601 has an example operating system 616.

The example computing device 601 is electronic equipment controlled by a central processing unit (CPU). In the illustrated example of FIG. 6, the computing device 601 is a laptop computer. In other examples, the computing device 601 can be implemented by any other suitable type of electronic equipment (e.g., a tablet, a desktop computer, a smartphone, a television, a server, a video game console, a handheld video game console, etc.). In the illustrated example of FIG. 6, the computer device 601 includes the user interface 610 to receive user input data. For example, the user interface 610 can include a keyboard, a mouse, a touchscreen, a touchpad, a microphone, a gaming pad, etc. Additionally or alternatively, the user interface 610 can be implemented as independent peripheral devices connected to the computing device 601 via one or more wireless and wired connections. In the illustrated example, the primary display 602 (e.g., the first display 102A, etc.) is incorporated into the computing device 601. In the illustrated example of FIG. 6, the first tag reader 608A is disposed on the left (compass west) of the primary display 602, the second tag reader 608B is disposed on the top (compass north) of the primary display 602, the third tag reader 608C is disposed on the right (compass east) of the primary display 602. While the primary display 602 includes the tag readers 608A, 608B, 608C in the illustrate example of FIG. 6, in other examples, the primary display 602 can include additional tag readers (e.g., a tag reader disposed on the bottom (compass south) of the primary display 602).

The secondary displays 604, 606 are standalone displays that are communicatively coupled to the computing device 601. As such, video content generated by the computing device 601 can be presented via the primary display 602 and the secondary displays 604, 606. In the illustrated example, the secondary displays 604, 606 include the tags 612A, 612B, 612C, 612D and the tags 614A, 614B, 614C, 614D, respectively. In the illustrated example of FIG. 6, the first tag 612A is disposed on the right (compass east) of the first secondary display 604, the second tag 612B is disposed on the bottom (compass south) of the first secondary display 604, the third tag 612C is disposed on the left (compass west) of the first secondary display 604, and the fourth tag 612D is disposed on the top (compass north) of the first secondary display 604. In the illustrated example of FIG. 6, the fifth tag 614A is disposed on the right (compass east) of the second secondary display 606, the sixth tag 614B is disposed on the bottom (compass south) of the second secondary display 606, the seventh tag 614C is disposed on the left (compass west) of the second secondary display 606, and the eighth tag 614D is disposed on the top (compass north) of the second secondary display 606. The example primary display 602 and the example secondary display 604, 606 can implement the example displays 102A, 102B, 102C, 102D, 102E.

In the illustrated example of FIG. 6, one of the tag readers 608A, 608B, 608C can detect one of the tags 612A, 612B, 612C, 612D when the first secondary display 604 is within a threshold distance from the respective side associated with the corresponding one of the tag readers 608A, 608B, 608C. Similarly, one of the tag readers 608A, 608B, 608C can detect one of the tags 614A, 614B, 614C, 614D when the second secondary display 606 is within a threshold distance from the respective side associated with the corresponding one of the tag readers 608A, 608B, 608C. For example, the second tag reader 608B can detect the tag 612C when the first secondary display 604 is positioned adjacent to the primary display 602 and within the threshold distance of the primary display 602. In some examples, the threshold distance can correspond to the read distance associated with the tags 612A, 612B, 612C, 612D, 614A, 614B, 614C, 614D (e.g., 1 foot, 3 feet, etc.). In other examples, the threshold distance can be manually set by a user and associated with a signal strength detected by one of the tag readers 608A, 608B, 608C (e.g., 1 inch, etc.). In some examples, if one of the tag readers 608A, 608B, 608C detects multiple tags, the tag reader indicates the detected tag with the greatest signal strength. In the illustrated example of FIG. 6, the tags 612B, 612D are disposed on the comparatively longer sides of the first secondary display 604 and the tags 612A, 612C are disposed on the relatively shorter sides of the first secondary display 604. Similarly, the tags 614A, 614C are disposed on the relatively longer sides of the second secondary display 606 and the tags 614B, 614D are disposed on the relatively shorter sides of the second secondary display 606. In the illustrated example of FIG. 6, the tags 612A, 612B, 612C, 612D, 614A, 614B, 614C, 614D are radio-frequency identification (RFID) tags and the tag readers 608A, 608B, 608C are RFID tag readers. In some such examples, the tags 612A, 612B, 612C, 612D, 614A, 614B, 614C, 614D are passive RFID tags that are powered by radio waves emitted by the tag readers 608A, 608B, 608C. As such, the tags 612A, 612B, 612C, 612D, 614A, 614B, 614C, 614D do not need to be coupled to a power source. Accordingly, the tags 612A, 612B, 612C, 612D, 614A, 614B, 614C, 614D can be coupled to the secondary displays 604, 606 after the manufacture of the secondary displays 604, 606 (e.g., by a user of the secondary displays 604, 606, etc.). In the illustrated example of FIG. 6, the tags 612A, 612B, 612C, 612D, 614A, 614B, 614C, 614D convey information regarding the secondary displays 604, 606 and the position of the tags 612A, 612B, 612C, 612D, 614A, 614B, 614C, 614D on the secondary displays 604, 606. In other examples, the tags 612A, 612B, 612C, 612D, 614A, 614B, 614C, 614D can be implemented with any other suitable technologies (e.g., active or semi-passive RFID tags, bar codes, beacons, etc.).

The operating system 616 is software and/or firmware operating on the computing device 601 that executes the basic functions (e.g., task management, memory management, hardware functions, etc.) of a computing system. In the illustrated example of FIG. 1, the operating system includes a function that enables the ordering and orientation of the primary display 602 and the secondary displays 604, 606 for purposes of user interaction. In the illustrated example of FIG. 6, the multi-display orientation determiner 110 interfaces with the operating system 616 to ensure the physical orientation and arrangement of the primary display 602 and the secondary displays 604, 606 is configured in the operating system 616. In some examples, the operating systems 616 can be implemented by a UNIX™ system, LINUX™ system, a WINDOWS™ system, a macOS™ system, etc.

In the illustrated example of FIG. 6, the third tag reader 608C detects the third tag 612C of the first secondary display 604. Based on this detection by the third tag reader 608C and subsequent data exchange between the tag 612C and tag reader 608C (e.g., the location of the tag 612C on the first secondary display 604, etc.), the multi-display orientation determiner 110 determines the first secondary display 604 is to the right of the primary display 602. Additionally, because the detected tag 612C is associated with a relatively shorter side of the first secondary display 604, the multi-display orientation determiner 110 determines the second secondary display is in the landscape orientation. In some examples, the multi-display orientation determiner 110 is able to determine the tag 612C is associated with a relatively shorter side (to then infer the orientation) based on tag information provided by tag 612C. For example, the tag information may include an indication of the location of the tag 612C relative to the first secondary display 604. In some examples, the tag information may include sufficient information to distinguish the locations of the two tags 612A, 612C associated with the relatively shorter sides so that the multi-display orientation determiner 110 would be able to determine if the first secondary display 604 were flipped by 180 degrees. In some examples, the tag information provided by the tag 612C is limited to a tag identifier that may be used to retrieve orientation information associated with the first secondary display from a lookup table or other data structure accessible by the computing device 601. In the illustrated example of FIG. 6, the first tag reader 608A detects the fifth tag 614A of the second secondary display 606. Based on this detection by the first tag reader 608A, the multi-display orientation determiner 110 determines the second secondary display 606 is to the left of the primary display 602. Additionally, because the detected tag 614A is associated with a relatively longer side of the second secondary display 606 (as indicated by tag information associated with the tag 614A), the multi-display orientation determiner 110 determines the second secondary display is in the portrait orientation. In the illustrated example, the multi-display orientation determiner 110 communicates with the operating system 616 to automatically configure the relative position of the secondary displays 604, 606 and the orientation of the secondary displays 604, 606.

In the illustrated example of FIG. 6, no secondary display is positioned above the primary display 602. As such, the second tag reader 608B does not detect a tag associated with a secondary display. In some examples, if the tag reader 608B does detect a tag, the multi-display orientation determiner 110 determines a second secondary display is positioned above the primary display 602. In some examples, based on the particular tag detected by the tag reader 608B, the multi-display orientation determiner 110 can determine the orientation of any second display positioned above the primary display 602.

In some examples, the tags 612A, 612B, 612C, 612D, 614A, 614B, 614C, 614D of the secondary displays 604, 606 are tag readers similar to the tag readers 608A, 608B, 608C of the primary display 602. In some such examples, a third secondary display could be positioned adjacent (e.g., above) the first secondary display 604 such that tags in the third secondary display are detected by the first secondary display 604 (specifically, the fourth tag 612D if the third secondary display is positioned above the first secondary display). Further, in some such examples, the tags 612A, 612B, 612C, 612D, which are also tag readers in this example, of first secondary display 604 may be in communication with one another. As a result, in response to the fourth tag 612D of the second secondary display detecting a third secondary display, the fourth tag 612D conveys that information to the tag 612C that is adjacent the primary display 602, and the tag 612C may then pass the information on to the tag reader 608C to be used by the multi-display orientation determiner 110 to determine the position and orientation of the third secondary display. In this manner, the position and orientation of a large array of secondary displays (e.g., a multi-panel display system as discussed above in conjunction with FIG. 5) may be automatically determined and configured in a manner similar to that described in conjunction with FIG. 5. In some examples, the secondary displays 604, 606 include a tag interface controller that interfaces the different tags/tag readers in each secondary display to enable information to be shared therebetween as outlined above.

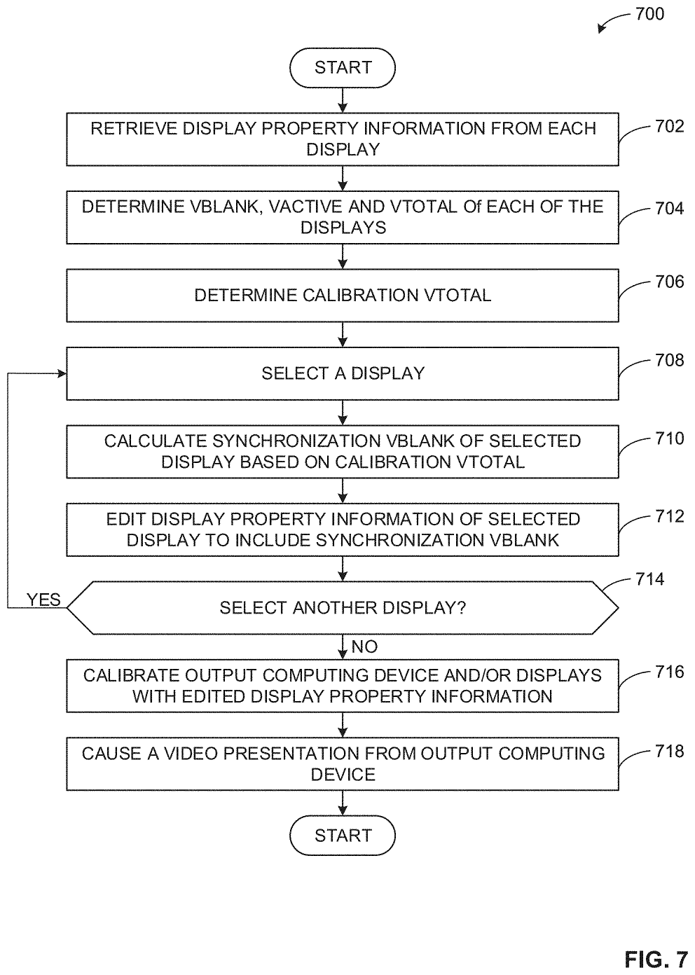

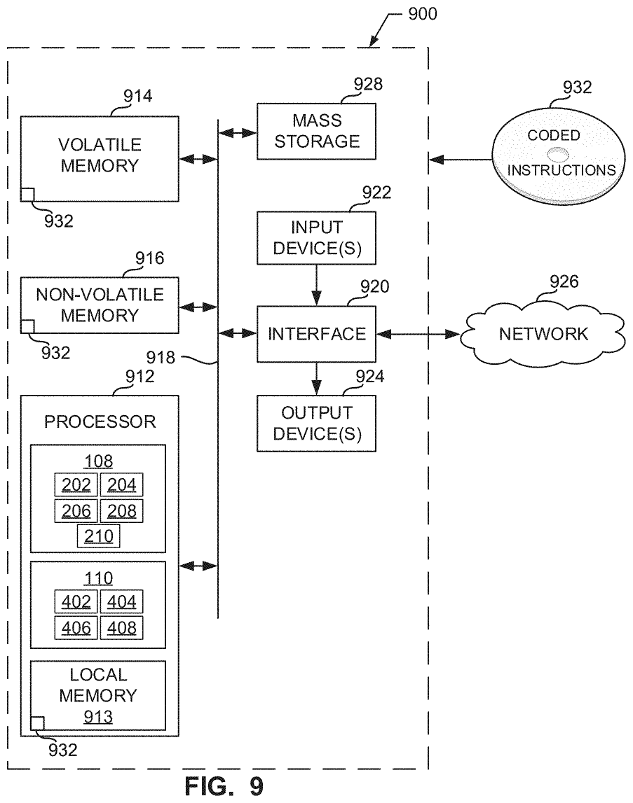

A flowchart representative of example hardware logic, machine readable instructions, hardware implemented state machines, and/or any combination thereof for implementing the example display synchronizer 108 of FIGS. 1 and 2 is shown in FIG. 7. The machine readable instructions may be one or more executable programs or portion(s) of an executable program for execution by a computer processor such as the processor 912 shown in the example processor platform 900 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 7, many other methods of implementing the example display synchronizer 108 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

FIG. 7 is a flowchart representative of example machine readable instructions which may be executed to implement the example display synchronizer 108 of FIGS. 1 and 2. The process 700 of FIG. 7 begins at block 702. At block 702, the display property interface 202 retrieves display property information from each coupled display. For example, the display property interface 202 can request display property information from each display coupled to the primary SOC 502 (e.g., the panels 506A, 506B, 506C, etc.) and each display coupled to a SOC coupled to the primary SOC 502 (e.g., the panels 508A, 508B, 508C, etc.). In such examples, the display property interface 202 can retrieve the display property information 510A, 510B, 510C, 512A, 512B, 512C from the panels 506A, 506B, 506C, 508A, 508B, 508C, respectively. In other examples, the panels 506A, 506B, 506C, 508A, 508B, 508C can automatically transmit the display property information 510A, 510B, 510C, 512A, 512B, 512C to display property interface 202 when they are coupled to the display synchronizer 108, the primary SOC 502, and/or the secondary SOC 504. In some examples, the display property interface 202 can receive the display information via a user interface (e.g., a user interface associated with a computing device implementing the display synchronizer 108, etc.). In some such examples, the display property interface 202 can prompt a user to input the display properties. In some examples, the display property information is retrieved from tags associated with the displays (e.g., the tags 612A, 612B, 612C, 612D, 614A, 614B, 614C, 614D of the secondary displays 604, 606 of FIG. 6).

At block 704, the display property reader 204 determines the vertical blanking interval, vertical active interval, and vertical total dimension of each of the displays. For example, the display property reader 204 can analyze the retrieved display property information 510A, 510B, 510C, 512A, 512B, 512C to determine the default vertical blanking interface (e.g., the vertical blanking interval 306, etc.), the vertical active dimension (e.g., the vertical active interval 308, etc.) and vertical total dimension (e.g., the vertical total dimension 304, etc.) of the coupled panels 506A, 506B, 506C, 508A, 508B, 508C, respectively. In some examples, the display property reader 204 can unencrypt the display property information 510A, 510B, 510C, 512A, 512B, 512C. In some examples, the display property reader 204 can perform any suitable analysis to determine the default vertical blanking interface and vertical total dimension of each of the panels 506A, 506B, 506C, 508A, 508B, 508C.

At block 706, the calibration target determiner 206 determines the calibration vertical total dimension. For example, the calibration target determiner 206 can determine the greatest (e.g., largest, longest in duration, etc.) vertical total dimension of the vertical total dimensions determined by the display property reader 204. In such examples, the calibration target determiner 206 sets the calibration vertical total dimension as the determined greatest vertical total dimension among all of the coupled displays. In other examples, the calibration target determiner 206 can determine the calibration total dimension by any other suitable means (e.g., the second greatest determined vertical total dimension, a fixed value above the vertical total dimension, a multiple of the vertical total dimension, etc.)

At block 708, the calibration target determiner 206 selects a display. For example, the calibration target determiner 206 can select the first panel 506A. In other examples, the calibration target determiner 206 can select a display among the unselected displays (e.g., a display that has yet to be calibrated, etc.). At block 710, the blanking interval calculator 208 calculates the synchronization vertical blanking interval of the selected display based on the calibration vertical total dimension. For example, the blanking interval calculator 208 can calculate the synchronization vertical blanking interval for the selected display by subtracting the vertical active interval 308 from the determined calibration vertical total dimension. In other examples, the blanking interval calculator 208 can determine the synchronization vertical blanking interval from any other suitable means.

At block 712, the display property editor 210 edits the display property information of the selected display to include the synchronization vertical blanking interval. For example, the display property editor 210 can edit the display property information associated with the selected display (e.g., the first display property information 510A of the first panel 506A, etc.) to include the calculated synchronization vertical blanking interval. In some examples, the display property editor 210 creates a temporary copy of the first display property information 510A and edits the copy to include the calculated synchronization vertical blanking interval. In other examples, the display property editor 210 can directly edit the retrieved copy of the display property editor 210.

At block 714, the calibration target determiner 206 determines if another display is to be selected. For example, the calibration target determiner 206 can determine if there are coupled displays that have yet to be calibrated. In other examples, the calibration target determiner 206 can determine if another display is to be calibrated by any other suitable means. If another display is to be selected, the process 700 returns to block 708. If another display is not to be selected, the process 700 advances to block 716.

At block 716, the display property interface 202 calibrates the displays with the edited display property information. For example, the display property interface 202 can transmit the updated display property information 510A, 510B, 510C, 512A, 512B, 512C back to the panels 506A, 506B, 506C, 508A, 508B, 508C. In other examples, the display property interface 202 can only transmit the respective determined synchronization vertical blanking intervals to the panels 506A, 506B, 506C, 508A, 508B, 508C. In such examples, the display property interface 202 can cause the panels 506A, 506B, 506C, 508A, 508B, 508C to edit the local copies of the display property information 510A, 510B, 510C, 512A, 512B, 512C to include the respective determined synchronization vertical blanking intervals.

At block 718, the display property interface 202 causes a video presentation from output computing device. For example, the display property interface 202 can causes a computing device associated with the display controller 104 to output a synchronized video presentation to the panels 506A, 506B, 506C, 508A, 508B, 508C. In such examples, because each of the panels 506A, 506B, 506C, 508A, 508B, 508C has the same vertical total dimension, the panels 506A, 506B, 506C, 508A, 508B, 508C will refresh at substantially a same time, which creates a seamless experience for the viewer. The process 700 then ends.

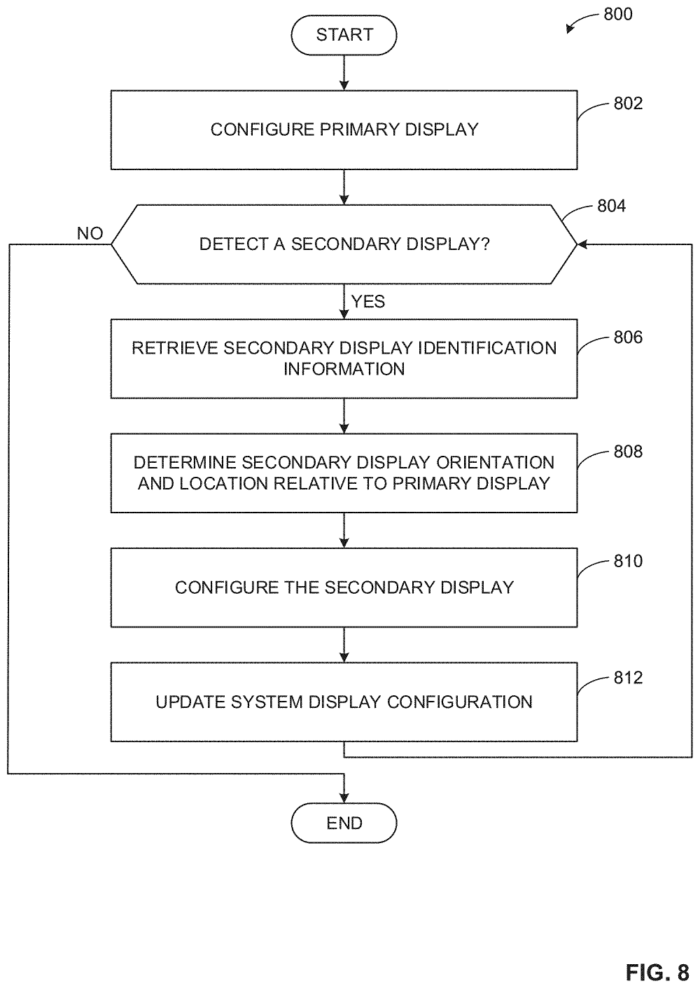

A flowchart representative of example hardware logic, machine readable instructions, hardware implemented state machines, and/or any combination thereof for implementing the multi-display orientation determiner 110 of FIGS. 1 and 4 is shown in FIG. 8. The machine readable instructions may be one or more executable programs or portion(s) of an executable program for execution by a computer processor such as the processor 912 shown in the example processor platform 900 discussed below in connection with FIG. 9. The program may be embodied in software stored on a non-transitory computer readable storage medium such as a CD-ROM, a floppy disk, a hard drive, a DVD, a Blu-ray disk, or a memory associated with the processor 912, but the entire program and/or parts thereof could alternatively be executed by a device other than the processor 912 and/or embodied in firmware or dedicated hardware. Further, although the example program is described with reference to the flowchart illustrated in FIG. 8, many other methods of implementing the example multi-display orientation determiner 110 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

FIG. 8 is a flowchart representative of example machine readable instructions which may be executed to implement the example multi-display orientation determiner of FIGS. 1 and 4. The process 800 of FIG. 8 begins at block 802. At block 802, the display configurer 402 configures the primary display 602. For example, the display configurer 402 can, based on the display attributes of the primary display 602, configure the resolution, refresh rate, scaling, orientation (e.g., landscape, orientation, etc.), etc. Additionally or alternatively, the display configurer 402 can configure based on a user setting (e.g., input via the user interface 610, etc.) and/or retrieved from a memory of the computing device 601.

At block 804, the display detector 404 determines if a secondary display is detected. For example, the display detector 404 can interface with one or more example tag readers 608A, 608B, 608C of the primary display 602 to determine if a tag (e.g., the tags 612A, 612B, 612C, 612D. 614A, 614B, 614C, 614D, etc.) associated with a secondary display (e.g., the secondary displays 604, 606, etc.) is detected. In such examples, if the tag readers 608A, 608B, 608C, 608D reads a tag associated with a secondary display, the display detector 404 determines a secondary display is detected. In other examples, the display detector 404 can determine if another display is detected by any other suitable means. If the display detector 404 detects a secondary display, the process 800 advances to block 806. If the display detector 404 does not detect secondary display, the process 800 ends.

At block 806, the display detector 404 retrieves secondary display identification information from the secondary display 604. For example, the display detector can, via the display interface 106, transmit a request to the secondary display 604 to retrieve the identification information associated with the secondary display (e.g., from a memory associated with the secondary display 604, etc.). In other examples, the display detector 404 can analyze the first secondary display 604 to determine the display property information of the first secondary display 604. In other examples, the display detector 404 can receive the display properties automatically upon the coupling of the display interface 106 and/or automatically from information stored in one or more of the tags 612A, 612B, 612C, 612D. In some examples, the information conveyed by the detected tag 612A, 612B, 612C, 612D includes information to identify the particular tag providing the information and/or the location of the tag on the secondary display.

At block 808, the orientation determiner 406 determines the secondary display location and orientation relative to primary display 602. For example, the orientation determiner 406 can determine the location of the secondary display 604 relative to the primary display 602. For example, the orientation determiner 406 can determine the first secondary display 604 is to the left (e.g., compass west), to the top (e.g., compass north) or to the right (e.g., compass east) of the primary display 602 based on whether a tag (e.g., one of the tags 612A, 612B, 612C, 612D, etc.) of the first secondary display 604 is detected by the first tag reader 608A, the second tag reader 608B, and/or the third tag reader 608C, respectively. In some examples, the orientation determiner 406 can determine the orientation of the secondary display 604. For example, if the orientation determiner 406 determines a tag reader on a left or right side of the primary display 602 (e.g., the tag readers 608A, 608C) detects a tag associated with a relatively shorter side of the first secondary display (e.g., the tags 612A, 612C, etc.) or determines a tag reader on the top or bottom of the primary display 602 (e.g., the tag reader 608B) detects a tag associated with a relatively longer side of the first secondary display (e.g., the tags 612B, 612D, etc.), the orientation determiner 406 determines the first secondary display is in the landscape orientation. That is, if the orientation determiner 406 determines the relative side length of the primary display 602 associated with the tag reader detecting the secondary display 604 matches the side length of the detected tag, the orientation determiner 406 determines the first secondary display 604 has the same orientation as the primary display 602. Similarly, if the orientation determiner 406 determines a tag reader on a left or right side of the primary display 602 (e.g., the tag readers 608A, 608C) detects a tag associated with a relatively longer side of the first secondary display 604 (e.g., the tags 612B, 612D, etc.) or determines a tag reader on the top or bottom of the primary display 602 (e.g., the tag reader 608B) detects a tag associated with a relatively shorter side of the first secondary display (e.g., the tags 612A, 612C, etc.), the orientation determiner 406 determines the first secondary display 604 is in the portrait orientation. That is, if the orientation determiner 406 determines the relative side length of the primary display 602 associated with the tag reader detecting the secondary display 604 does not matches the relative side length of the detected tag, the orientation determiner 406 determines the first secondary display 604 has the opposite orientation as the primary display 602.

At block 810, the display configurer 402 configures the first secondary display 604. For example, the display configurer 402 can cause the display controller 104 and/or the display interface 106 to properly configure the orientation (as either landscape and/or portrait configuration, etc.). In some examples, the display configurer 402 can configure the first secondary display 604 based on the properties of the primary display 602. For example, the display configurer 402 can configure the first secondary display 604 to have matching refresh and/or timing characteristics as the primary display 602.

At block 812, the operating system interface 408 updates system display configurations. For examples, the display configurer 402 can interface and communicate with an operating system associated with the display controller 104 and/or primary display 102A. For example, the operating system interface 408 can cause the operating system to properly order and orient the primary display and selected secondary displays. That is, the operating system interface 408 can ensure the operating system is properly configured to reflect the physical orientation and layout of the coupled displays. In some examples, blocks 806-812 are performed automatically in response to detection of a secondary display (at block 804) without any manual inputs needing to be entered by a user.

The machine readable instructions described herein may be stored in one or more of a compressed formats, an encrypted format, a fragmented format, a compiled format, an executable format, a packaged format, etc. Machine readable instructions as described herein may be stored as data (e.g., portions of instructions, code, representations of code, etc.) that may be utilized to create, manufacture, and/or produce machine executable instructions. For example, the machine readable instructions may be fragmented and stored on one or more storage devices and/or computing devices (e.g., servers). The machine readable instructions may require one or more of installation, modification, adaptation, updating, combining, supplementing, configuring, decryption, decompression, unpacking, distribution, reassignment, compilation, etc. in order to make them directly readable, interpretable, and/or executable by a computing device and/or other machine. For example, the machine readable instructions may be stored in multiple parts, which are individually compressed, encrypted, and stored on separate computing devices, wherein the parts when decrypted, decompressed, and combined form a set of executable instructions that implement a program such as that described herein.

In another example, the machine readable instructions may be stored in a state in which they may be read by a computer, but require addition of a library (e.g., a dynamic link library (DLL)), a software development kit (SDK), an application programming interface (API), etc. in order to execute the instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, the disclosed machine readable instructions and/or corresponding program(s) are intended to encompass such machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example processes of FIGS. 7 and 8 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

As used herein, singular references (e.g., “a”, “an”, “first”, “second”, etc.) do not exclude a plurality. The term “a” or “an” entity, as used herein, refers to one or more of that entity. The terms “a” (or “an”), “one or more”, and “at least one” can be used interchangeably herein. Furthermore, although individually listed, a plurality of means, elements or method actions may be implemented by, e.g., a single unit or processor. Additionally, although individual features may be included in different examples or claims, these may possibly be combined, and the inclusion in different examples or claims does not imply that a combination of features is not feasible and/or advantageous.

FIG. 9 is a block diagram of an example processor platform 1000 structured to execute the instructions of FIGS. 7 and/or 8 to implement the display controller 104 of FIG. 1. The processor platform 1000 can be, for example, a server, a personal computer, a workstation, a self-learning machine (e.g., a neural network), a mobile device (e.g., a cell phone, a smart phone, a tablet such as an iPad′), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 900 of the illustrated example includes a processor 912. The processor 912 of the illustrated example is hardware. For example, the processor 912 can be implemented by one or more integrated circuits, logic circuits, microprocessors, GPUs, DSPs, or controllers from any desired family or manufacturer. The hardware processor may be a semiconductor based (e.g., silicon based) device. In this example, the processor 912 implements the display property interface 202, the display property reader 204, the calibration target determiner 206, the blanking interval calculator 208, the display property editor 210, the display configurer 402, the display detector 404, the orientation determiner 406, and the operating system interface 408.

The processor 912 of the illustrated example includes a local memory 913 (e.g., a cache). The processor 912 of the illustrated example is in communication with a main memory including a volatile memory 914 and a non-volatile memory 916 via a bus 918. The volatile memory 914 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 916 may be implemented by flash memory and/or any other desired type of memory device. Access to the main memory 914, 916 is controlled by a memory controller.

The processor platform 900 of the illustrated example also includes an interface circuit 920. The interface circuit 920 may be implemented by any type of interface standard, such as an Ethernet interface, a universal serial bus (USB), a Bluetooth® interface, a near field communication (NFC) interface, and/or a PCI express interface.

In the illustrated example, one or more input devices 922 are connected to the interface circuit 920. The input device(s) 922 permit(s) a user to enter data and/or commands into the processor 912. The input device(s) 922 can be implemented by, for example, an audio sensor, a microphone, a camera (still or video), a keyboard, a button, a mouse, a touchscreen, a track-pad, a trackball, an isopoint device, and/or a voice recognition system.

One or more output devices 924 are also connected to the interface circuit 920 of the illustrated example. The output devices 924 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 920 of the illustrated example, thus, typically includes a graphics driver card, a graphics driver chip and/or a graphics driver processor.

The interface circuit 920 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 926. The communication can be via, for example, an Ethernet connection, a digital subscriber line (DSL) connection, a telephone line connection, a coaxial cable system, a satellite system, a line-of-site wireless system, a cellular telephone system, etc.

The processor platform 900 of the illustrated example also includes one or more mass storage devices 928 for storing software and/or data. Examples of such mass storage devices 928 include floppy disk drives, hard drive disks, compact disk drives, Blu-ray disk drives, redundant array of independent disks (RAID) systems, and digital versatile disk (DVD) drives.

The machine executable instructions 932 of FIGS. 7 and 8 may be stored in the mass storage device 928, in the volatile memory 914, in the non-volatile memory 916, and/or on a removable non-transitory computer readable storage medium such as a CD or DVD.

The following pertain to further examples disclosed herein.

Example 1 includes an apparatus comprising at least one memory, and at least one processor to execute instructions to detect, via a tag reader on a first display, a tag on a second display, the first display and second display communicatively coupled to a computing device, determine, based on a location of the tag reader relative to the first display, a position of the second display relative to the first display, and update an operating system of the computing device based on the determined position.

Example 2 includes the apparatus of example 1, wherein the at least one processor is further to determine, based on information provided by the tag, an orientation of the second display, and update the operating system of the computing device based on the determined orientation.

Example 3 includes the apparatus of example 2, wherein the second display includes a short side and a long side, and the information indicates whether tag is disposed along the short side or the long side.

Example 4 includes the apparatus of example 2, wherein the information indicates a location of the tag relative to the second display.

Example 5 includes the apparatus of example 1, wherein first display includes a first side, and the second display includes a second side, the tag reader is disposed along the first side, the tag is disposed along the second side, and the at least one processor is to detects the tag when the second display is positioned with the second side adjacent the first side and within a threshold distance of the first side.

Example 6 includes the apparatus of example 5, wherein the tag is a first tag, and a second tag is disposed along a third side that is substantially perpendicular to the second side, and the at least one processor is further to detect, via the tag reader, the second tag when the second display is positioned with the third side adjacent the first side and within the threshold distance of the first side, and in response to the detecting of the first tag, determine the second display is in a landscape orientation, and in response to the detecting the second tag, determine the second display is in a portrait orientation.

Example 7 includes the apparatus of example 1, wherein the tag reader is a radio-frequency identification (RFID) tag reader, and the tag is a RFID tag.

Example 8 includes the apparatus of example 1, wherein the tag is a first tag disposed on a first side of the second display, the second display includes a second tag disposed on a second side of the second display, the second display includes a third tag disposed on a third side of the second display, and the second display includes a fourth tag disposed on a fourth side of the second display.

Example 9 includes the apparatus of example 1, wherein the tag reader is one of a plurality of tag readers, different ones of the plurality of tag readers disposed on different sides of the first display.

Example 10 includes the apparatus of example 1, wherein the at least one processor is further to obtain, via the tag reader, information from the tag, the information including display properties of the second display, and update the operating system of the computing device based on the display properties.

Example 11 includes the apparatus of example 1, wherein the at least one processor is further to determine, based a comparison of first display properties and second display properties, a calibration vertical total dimension, the first display properties associated with the first display and the second display properties associated with the second display, and modify at least one of the first display properties or the second display properties based on the calibration vertical total dimension such that the first display and the second display will refresh at substantially a same time.

Example 12 includes an apparatus comprising a display detector to detect, via a tag reader on a first display, a tag on a second display, the first display and second display communicatively coupled to a computing device, an orientation determiner to determine, based on a location of the tag reader relative to the first display, a position of the second display relative to the first display, and an operating system interface to update an operating system of the computing device based on the determined position.

Example 13 includes the apparatus of example 12, further including the orientation determiner to determine, based on information provided by the tag, an orientation of the second display, and the operating system interface to update the operating system of the computing device based on the determined orientation.

Example 14 includes the apparatus of example 13, wherein the second display includes a short side and a long side, and the information indicates whether tag is disposed along the short side or the long side.

Example 15 includes the apparatus of example 13, wherein the information indicates a location of the tag relative to the second display.

Example 16 includes the apparatus of example 12, wherein first display includes a first side, and the second display includes a second side, the tag reader is disposed along the first side, the tag is disposed along the second side, and the display detector is to detect the tag when the second display is positioned with the second side adjacent the first side and within a threshold distance of the first side.

Example 17 includes the apparatus of example 16, wherein the tag is a first tag, and a second tag is disposed along a third side that is substantially perpendicular to the second side, and further including the display detector to detect, via the tag reader, the second tag when the second display is positioned with the third side adjacent the first side and within the threshold distance of the first side, and the orientation determiner to determine the second display is in a landscape orientation in response to the detecting of the first tag, and determine the second display is in a portrait orientation, in response to the detecting the second tag.

Example 18 includes the apparatus of example 12, wherein the tag reader is a radio-frequency identification (RFID) tag reader, and the tag is a RFID tag.

Example 19 includes the apparatus of example 12, wherein the tag is a first tag disposed on a first side of the second display, the second display includes a second tag disposed on a second side of the second display, the second display includes a third tag disposed on a third side of the second display, and the second display includes a fourth tag disposed on a fourth side of the second display.

Example 20 includes the apparatus of example 12, wherein the tag reader is one of a plurality of tag readers, different ones of the plurality of tag readers disposed on different sides of the first display.

Example 21 includes the apparatus of example 12, further including the display detector to obtain, via the tag reader, information from the tag, the information including display properties of the second display, and the operating system interface to update the operating system of the computing device based on the display properties.

Example 22 includes the apparatus of example 12, further including a calibration target determiner to determine, based a comparison of first display properties and second display properties, a calibration vertical total dimension, the first display properties associated with the first display and the second display properties associated with the second display, and a display property editor to modify at least one of the first display properties or the second display properties based on the calibration vertical total dimension such that the first display and the second display will refresh at substantially a same time.

Example 23 includes At least one non-transitory computer readable medium comprising instructions that, when executed, cause a machine to at least detect, via a tag reader on a first display, a tag on a second display, the first display and second display communicatively coupled to a computing device, determine, based on a location of the tag reader relative to the first display, a position of the second display relative to the first display, and update an operating system of the computing device based on the determined position.

Example 24 includes the at least one non-transitory computer readable medium of example 23, wherein the instructions, when executed, further cause the machine to determine, based on information provided by the tag, an orientation of the second display, and update the operating system of the computing device based on the determined orientation.

Example 25 includes the at least one non-transitory computer readable medium of example 24, wherein the second display includes a short side and a long side, and the information indicates whether tag is disposed along the short side or the long side.

Example 26 includes the at least one non-transitory computer readable medium of example 24, wherein the information indicates a location of the tag relative to the second display.

Example 27 includes the at least one non-transitory computer readable medium of example 23, wherein first display includes a first side, and the second display includes a second side, the tag reader is disposed along the first side, the tag is disposed along the second side, and the detecting of the tag to occur when the second display is positioned with the second side adjacent the first side and within a threshold distance of the first side.

Example 28 includes the at least one non-transitory computer readable medium of example 27, wherein the tag is a first tag, a second tag is disposed along a third side that is substantially perpendicular to the second side, and the instructions, when executed, further cause the machine to detect, via the tag reader, the second tag when the second display is positioned with the third side adjacent the first side and within the threshold distance of the first side, and in response to the detecting of the first tag, determine the second display is in a landscape orientation, and in response to the detecting the second tag, determine the second display is in a portrait orientation.

Example 29 includes the at least one non-transitory computer readable medium of example 23, wherein the tag reader is a radio-frequency identification (RFID) tag reader, and the tag is a RFID tag.

Example 30 includes the at least one non-transitory computer readable medium of example 23, wherein the tag is a first tag disposed on a first side of the second display, the second display includes a second tag disposed on a second side of the second display, the second display includes a third tag disposed on a third side of the second display, and the second display includes a fourth tag disposed on a fourth side of the second display.

Example 31 includes the at least one non-transitory computer readable medium of example 23, wherein the tag reader is one of a plurality of tag readers, different ones of the plurality of tag readers disposed on different sides of the first display.

Example 32 includes the at least one non-transitory computer readable medium of example 23, wherein the instructions, when executed, further cause the machine to obtain, via the tag reader, information from the tag, the information including display properties of the second display, and update the operating system of the computing device based on the display properties.

Example 33 includes the at least one non-transitory computer readable medium of example 23, wherein the instructions, when executed, further cause the machine to determine, based a comparison of first display properties and second display properties, a calibration vertical total dimension, the first display properties associated with the first display and the second display properties associated with the second display, and modify at least one of the first display properties or the second display properties based on the calibration vertical total dimension such that the first display and the second display will refresh at substantially a same time.

Example 34 includes a method comprising detecting, via a tag reader on a first display, a tag on a second display, the first display and second display communicatively coupled to a computing device, determining, based on a location of the tag reader relative to the first display, a position of the second display relative to the first display, and updating an operating system of the computing device based on the determined position.

Example 35 includes the method of example 34, further including determining, based on information provided by the tag, an orientation of the second display, and updating the operating system of the computing device based on the determined orientation.

Example 36 includes the method of example 35, wherein the second display includes a short side and a long side, and the information indicates whether tag is disposed along the short side or the long side.

Example 37 includes the method of example 35, wherein the information indicates a location of the tag relative to the second display.

Example 38 includes the method of example 34, wherein first display includes a first side, and the second display includes a second side, the tag reader is disposed along the first side, the tag is disposed along the second side, and the detecting of the tag to occur when the second display is positioned with the second side adjacent the first side and within a threshold distance of the first side.

Example 39 includes the method of example 38, wherein the tag is a first tag, and a second tag is disposed along a third side that is substantially perpendicular to the second side, further including detecting, via the tag reader, the second tag when the second display is positioned with the third side adjacent the first side and within the threshold distance of the first side, and in response to the detecting of the first tag, determining the second display is in a landscape orientation, and in response to the detecting the second tag, determining the second display is in a portrait orientation.

Example 40 includes the method of example 34, wherein the tag reader is a radio-frequency identification (RFID) tag reader, and the tag is a RFID tag.

Example 41 includes the method of example 34, wherein the tag is a first tag disposed on a first side of the second display, the second display includes a second tag disposed on a second side of the second display, the second display includes a third tag disposed on a third side of the second display, and the second display includes a fourth tag disposed on a fourth side of the second display.

Example 42 includes the method of example 34, wherein the tag reader is one of a plurality of tag readers, different ones of the plurality of tag readers disposed on different sides of the first display.

Example 43 includes the method of example 34, further including obtaining, via the tag reader, information from the tag, the information including display properties of the second display, and updating the operating system of the computing device based on the display properties.

Example 44 includes the method of example 34, further including determining, based a comparison of first display properties and second display properties, a calibration vertical total dimension, the first display properties associated with the first display and the second display properties associated with the second display, and modifying at least one of the first display properties or the second display properties based on the calibration vertical total dimension such that the first display and the second display will refresh at substantially a same time.

Example 45 includes an apparatus comprising at least one memory, and at least one processor to execute instructions to determine, based a comparison of first display properties and second display properties, a calibration vertical total dimension, the first display properties associated with a first display and the second display properties associated with a second display, modify at least one of the first display properties or the second display properties based on the calibration vertical total dimension, and cause a presentation of, using the at least one of the edited first display properties or the edited second display properties, a synchronized video presentation on the first display and the second display, the first display and the second display to refresh at substantially a same time.

Example 46 includes the apparatus of example 45, wherein the calibration vertical total dimension is based on a larger of a first vertical resolution of the first display or a second vertical resolution of the second display.

Example 47 includes the apparatus of example 46, wherein the second vertical resolution is the larger of the first vertical resolution and the second vertical resolution, and the at least one processor editing at least one of the first display properties or the second display properties includes determining, based on the calibration vertical total dimension and a vertical active interval of the first display, a synchronization vertical blanking interval, and modifying the first display properties to include the synchronization vertical blanking interval.

Example 48 includes the apparatus of example 47, wherein the synchronization vertical blanking interval is equal to a difference between the calibration vertical total dimension and the vertical active interval.

Example 49 includes the apparatus of example 45, wherein the first display and the second display are panels in a multi-panel display system.

Example 50 includes the apparatus of example 45, wherein the at least one processor is implemented in a first system-on-chip, the first display is communicatively coupled to the first system-on-chip, and the second display is communicatively coupled to a second system-on-chip, the first system-on-chip communicatively coupled to the second system-on-chip.

Example 51 includes the apparatus of example 50, wherein the first system-on-chip drives a reference clock to control a refresh timing of the first display and the second display, the at least one processor to cause the first system-on-chip to transmit a frame synchronization signal to the second system-on-chip, the second system-on-chip to, in response to receiving the frame synchronization signal, cause the second display to refresh.

Example 52 includes the apparatus of example 45, wherein the at least one processor is further to detect, via a tag reader on the first display, a tag on the second display, and determine, based on a location of the tag reader relative to the first display, a position of the second display relative to the first display.

Example 53 includes an apparatus comprising a calibration target determiner to determine, based a comparison of first display properties and second display properties, a calibration vertical total dimension, the first display properties associated with a first display and the second display properties associated with a second display, a display property editor to modify at least one of the first display properties or the second display properties based on the calibration vertical total dimension, and a display property interface to cause a presentation of, using the at least one of the edited first display properties or the edited second display properties, a synchronized video presentation on the first display and the second display such that the first display and the second display to refresh at substantially a same time.

Example 54 includes the apparatus of example 53, wherein the calibration vertical total dimension is based on a larger of a first vertical resolution of the first display or a second vertical resolution of the second display.

Example 55 includes the apparatus of example 54, wherein the second vertical resolution is the larger of the first vertical resolution and the second vertical resolution, and further including a blanking interval calculator to determine, based on the calibration vertical total dimension and a vertical active interval of the first display, a synchronization vertical blanking interval, and the display property editor modifies the first display properties to include the synchronization vertical blanking interval.

Example 56 includes the apparatus of example 55, wherein the synchronization vertical blanking interval is equal to a difference between the calibration vertical total dimension and the vertical active interval and.

Example 57 includes the apparatus of example 53, wherein the first display and the second display are panels in a multi-panel display system.

Example 58 includes the apparatus of example 53, wherein the first display is communicatively coupled to the first system-on-chip, and the second display is communicatively coupled to a second system-on-chip, the first system-on-chip communicatively coupled to the second system-on-chip.

Example 59 includes the apparatus of example 51, wherein the first system-on-chip drives a reference clock to control a refresh timing of the first display and the second display, the at least one processor to cause the first system-on-chip to transmit a frame synchronization signal to the second system-on-chip, the second system-on-chip to, in response to receiving the frame synchronization signal, cause the second display to refresh.

Example 60 includes the apparatus of example 53, further including a display detector to detect, via a tag reader on the first display, a tag on the second display, and an orientation determiner to determine, based on a location of the tag reader relative to the first display, a position of the second display relative to the first display.

Example 61 includes At least one non-transitory computer readable medium comprising instructions that, when executed, cause a machine to at least determine, based a comparison of first display properties and second display properties, a calibration vertical total dimension, the first display properties associated with a first display and the second display properties associated with a second display, modify at least one of the first display properties or the second display properties based on the calibration vertical total dimension, and cause a presentation of, using the at least one of the edited first display properties or the edited second display properties, a synchronized video presentation on the first display and the second display such that the first display and the second display to refresh at substantially a same time.

Example 62 includes the at least one non-transitory computer readable medium example 61, wherein the calibration vertical total dimension is based on a larger of a first vertical resolution of the first display or a second vertical resolution of the second display.

Example 63 includes the at least one non-transitory computer readable medium example 62, wherein the second vertical resolution is the larger of the first vertical resolution and the second vertical resolution, and wherein the instructions, when executed, further cause the machine to determine, based on the calibration vertical total dimension and a vertical active interval of the first display, a synchronization vertical blanking interval, and modify the first display properties to include the synchronization vertical blanking interval.

Example 64 includes the at least one non-transitory computer readable medium example 63, wherein the synchronization vertical blanking interval is equal to a difference between the calibration vertical total dimension and the vertical active interval and.

Example 65 includes the at least one non-transitory computer readable medium example 63, wherein the first display and the second display are panels on a multi-panel display system.

Example 66 includes the at least one non-transitory computer readable medium example 61, wherein the first display is communicatively coupled to the first system-on-chip, and the second display is communicatively coupled to a second system-on-chip, the first system-on-chip communicatively coupled to the second system-on-chip.

Example 67 includes the at least one non-transitory computer readable medium example 66, wherein the first system-on-chip drives a reference clock to control a refresh timing of the first display and the second display, the at least one processor to cause the first system-on-chip to transmit a frame synchronization signal to the second system-on-chip, the second system-on-chip to, in response to receiving the frame synchronization signal, cause the second display to refresh.

Example 68 includes the at least one non-transitory computer readable medium example 61, wherein the instructions, when executed, further cause a machine to detect, via a tag reader on the first display, a tag on the second display, and determine, based on a location of the tag reader relative to the first display, a position of the second display relative to the first display.

Example 69 includes a method comprising determining, based a comparison of first display properties and second display properties, a calibration vertical total dimension, the first display properties associated with a first display and the second display properties associated with a second display, modifying at least one of the first display properties or the second display properties based on the calibration vertical total dimension, and causing a presentation of, using the at least one of the edited first display properties or the edited second display properties, a synchronized video presentation on the first display and the second display such that the first display and the second display to refresh at substantially a same time.

Example 70 includes the method of example 69, wherein the calibration vertical total dimension is based on a larger of a first vertical resolution of the first display or a second vertical resolution of the second display.

Example 71 includes the method of example 70, wherein the second vertical resolution is the larger of the first vertical resolution and the second vertical resolution, and the editing at least one of the first display properties or the second display properties includes determining, based on the calibration vertical total dimension and a vertical active interval of the first display, a synchronization vertical blanking interval, and modifying the first display properties to include the synchronization vertical blanking interval.

Example 72 includes the method of example 70, wherein the synchronization vertical blanking interval is equal to a difference between the calibration vertical total dimension and the vertical active interval and.

Example 73 includes the method of example 69, wherein the first display and the second display are panels in a multi-panel display system.

Example 74 includes the method of example 69, wherein the first display is communicatively coupled to the first system-on-chip, and the second display is communicatively coupled to a second system-on-chip, the first system-on-chip communicatively coupled to the second system-on-chip.

Example 75 includes the method of example 74, wherein the first system-on-chip drives a reference clock to control a refresh timing of the first display and the second display, the at least one processor to cause the first system-on-chip to transmit a frame synchronization signal to the second system-on-chip, the second system-on-chip to, in response to receiving the frame synchronization signal, cause the second display to refresh.

Example 76 includes the method of example 69, further including detecting, via a tag reader on the first display, a tag on the second display, and determining, based on a location of the tag reader relative to the first display, a position of the second display relative to the first display.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

The following claims are hereby incorporated into this Detailed Description by this reference, with each claim standing on its own as a separate embodiment of the present disclosure.

1. An apparatus comprising:
at least one memory; and
at least one processor to execute instructions to:
detect, via a tag reader on a first display, a tag on a second display, the first display and second display communicatively coupled to a computing device;
determine, based on a location of the tag reader relative to the first display, a position of the second display relative to the first display; and
update an operating system of the computing device based on the determined position.

2. The apparatus of claim 1, wherein the at least one processor is further to:
determine, based on information provided by the tag, an orientation of the second display; and
update the operating system of the computing device based on the determined orientation.

3. The apparatus of claim 2, wherein the second display includes a short side and a long side, and the information indicates whether tag is disposed along the short side or the long side.

4. The apparatus of claim 2, wherein the information indicates a location of the tag relative to the second display.

5. The apparatus of claim 1, wherein first display includes a first side and the second display includes a second side, the tag reader is disposed along the first side, the tag is disposed along the second side, and the at least one processor is to detects the tag when the second display is positioned with the second side adjacent the first side and within a threshold distance of the first side.

6. The apparatus of claim 5, wherein the tag is a first tag, and a second tag is disposed along a third side that is substantially perpendicular to the second side, and the at least one processor is further to:
detect, via the tag reader, the second tag when the second display is positioned with the third side adjacent the first side and within the threshold distance of the first side; and
in response to the detecting of the first tag, determine the second display is in a landscape orientation; and
in response to the detecting the second tag, determine the second display is in a portrait orientation.

7. The apparatus of claim 1, wherein the tag reader is a radio-frequency identification (RFID) tag reader and the tag is a RFID tag.

8. (canceled)

9. The apparatus of claim 1, wherein the tag reader is one of a plurality of tag readers, different ones of the plurality of tag readers disposed on different sides of the first display.

10. The apparatus of claim 1, wherein the at least one processor is further to:
obtain, via the tag reader, information from the tag, the information including display properties of the second display; and
update the operating system of the computing device based on the display properties.

11. The apparatus of claim 1, wherein the at least one processor is further to:
determine, based a comparison of first display properties and second display properties, a calibration vertical total dimension, the first display properties associated with the first display and the second display properties associated with the second display; and
modify at least one of the first display properties or the second display properties based on the calibration vertical total dimension such that the first display and the second display will refresh at substantially a same time.

12. An apparatus comprising:
a display detector to detect, via a tag reader on a first display, a tag on a second display, the first display and second display communicatively coupled to a computing device;
an orientation determiner to determine, based on a location of the tag reader relative to the first display, a position of the second display relative to the first display; and
an operating system interface to update an operating system of the computing device based on the determined position.

13. The apparatus of claim 12, further including:
the orientation determiner to determine, based on information provided by the tag, an orientation of the second display; and
the operating system interface to update the operating system of the computing device based on the determined orientation.

14. The apparatus of claim 13, wherein the second display includes a short side and a long side, and the information indicates whether tag is disposed along the short side or the long side.

15. The apparatus of claim 13, wherein the information indicates a location of the tag relative to the second display.

16. The apparatus of claim 12, wherein first display includes a first side and the second display includes a second side, the tag reader is disposed along the first side, the tag is disposed along the second side, and the display detector is to detect the tag when the second display is positioned with the second side adjacent the first side and within a threshold distance of the first side.

17. The apparatus of claim 16, wherein the tag is a first tag, and a second tag is disposed along a third side that is substantially perpendicular to the second side, and further including:
the display detector to detect, via the tag reader, the second tag when the second display is positioned with the third side adjacent the first side and within the threshold distance of the first side; and
the orientation determiner to:
determine the second display is in a landscape orientation in response to the detecting of the first tag; and
determine the second display is in a portrait orientation, in response to the detecting the second tag.

18. The apparatus of claim 12, wherein the tag reader is a radio-frequency identification (RFID) tag reader and the tag is a RFID tag.

19. (canceled)

20. The apparatus of claim 12, wherein the tag reader is one of a plurality of tag readers, different ones of the plurality of tag readers disposed on different sides of the first display.

21.-22. (canceled)

23. At least one non-transitory computer readable medium comprising instructions that, when executed, cause a machine to at least:
detect, via a tag reader on a first display, a tag on a second display, the first display and second display communicatively coupled to a computing device;
determine, based on a location of the tag reader relative to the first display, a position of the second display relative to the first display; and
update an operating system of the computing device based on the determined position.

24. The at least one non-transitory computer readable medium of claim 23, wherein the instructions, when executed, further cause the machine to:
determine, based on information provided by the tag, an orientation of the second display; and
update the operating system of the computing device based on the determined orientation.

25. The at least one non-transitory computer readable medium of claim 24, wherein the second display includes a short side and a long side, and the information indicates whether tag is disposed along the short side or the long side.

26. (canceled)

27. The at least one non-transitory computer readable medium of claim 23, wherein first display includes a first side and the second display includes a second side, the tag reader is disposed along the first side, the tag is disposed along the second side, and the detecting of the tag to occur when the second display is positioned with the second side adjacent the first side and within a threshold distance of the first side.

28. The at least one non-transitory computer readable medium of claim 27, wherein the tag is a first tag, a second tag is disposed along a third side that is substantially perpendicular to the second side, and the instructions, when executed, further cause the machine to:
detect, via the tag reader, the second tag when the second display is positioned with the third side adjacent the first side and within the threshold distance of the first side; and
in response to the detecting of the first tag, determine the second display is in a landscape orientation; and
in response to the detecting the second tag, determine the second display is in a portrait orientation.

29. (canceled)

30. The at least one non-transitory computer readable medium of claim 23, wherein the tag is a first tag disposed on a first side of the second display, the second display includes a second tag disposed on a second side of the second display, the second display includes a third tag disposed on a third side of the second display, and the second display includes a fourth tag disposed on a fourth side of the second display.

31. (canceled)

32. The at least one non-transitory computer readable medium of claim 23, wherein the instructions, when executed, further cause the machine to:
obtain, via the tag reader, information from the tag, the information including display properties of the second display; and
update the operating system of the computing device based on the display properties.

33.-76. (canceled)
